(19) United States
(12) Patent Application Publication
(10) Pub. No.: US 2002/0038960 A1
(43) Pub. Date: Apr. 4, 2002

(54) Hidden visor extender

(76) Inventor: Ursula Theresia Rounds, Eugene, OR (US)

Correspondence Address: Ursula T. Rounds, 4950 Barger Dr., Eugene, OR, 97402, US

(21) Appl. No.: 09/922,172

(22) Filed: Aug. 2, 2001

Related U.S. Application Data
(60) Provisional application No. 60/224,211, filed on Aug. 10, 2000.

(51) Int. Cl. B60J 3/00

(52) U.S. Cl. 296/97.8

(57) ABSTRACT

A visor for a motor vehicle that includes a primary visor and a visor extender. The primary visor has spaced apart front and back covers forming a slot therebetween. The covers are attached at their opposing side edges and along their opposing upper longitudinal edges, a longitudinal opening being defined by the opposing lower longitudinal edges. A visor extender is slidably received within the slot and extends through the longitudinal opening. A stop bar is attached to the inner longitudinal edge of the visor extender. The stop bar has first and second ends extending beyond each of the side edges of the visor extender which are received in grooves extending between the front and back covers adjacent their opposing side edges. The visor extender has a grip bar attached to at least a portion of the outer longitudinal edge of the visor extender.

### CROSS-REFERENCE TO RELATED APPLICATIONS

This application claims the benefit of U.S. Provisional Application No. 60/224,211, filed Aug. 10, 2000.

### BACKGROUND OF THE INVENTION

This invention relates to a visor extender for use in motor vehicles in conjunction with a primary visor mechanism.

Sun visors are used in motor vehicles to block the sun from shining into the eyes of the operator or front seat passenger. Such conventional sun visors provide adequate blocking when the sun is elevated substantially above the horizon. However, as the position of the sun approaches the horizon, conventional sun visors do not provide adequate blocking.

### SUMMARY OF THE INVENTION

The visor extender of the present invention is located fully inside a primary visor when not in use, i.e., its “retracted” position, but which can be withdrawn (“extended” or lowered) from its retracted position when needed to provide the driver with shielding from the sun's rays when required, e.g., when the sun is in a position below the lower edge of the primary visor.

The visor extender is preferably made of a UV resistant plastic having a green or amber color.

### BRIEF DESCRIPTION OF THE DRAWINGS

FIG. 1 is a cutaway front view of the primary visor mechanism with the front cover of the primary visor removed to show the position of the visor extender of the present invention;

FIG. 2 is a cutaway front view similar to FIG. 1 but with the visor extender in a partially extended position;

FIG. 3 is a cutaway front view similar to FIGS. 1 and 2 but with the visor extender in its fully extended position; and

FIG. 4 is a front view of the primary visor and associated mechanism with the visor extender in its fully retracted position.

### DESCRIPTION OF PREFERRED EMBODIMENTS

In the drawings the reference numbers refer to the following parts:

1 is the swing arm for the primary visor mechanism;

2 is the back cover of the primary visor;

3 is the front cover of the primary visor;

4 is the visor extender of the present invention;

5 is a soft layer of scratch resistant fabric;

6 is the grip bar for the visor extender 4;

7 is a stop bar for visor extender 4;

8 are grooves for receiving the outer ends of stop bar 7; and

10 is the primary visor and its associated mechanism.

The primary visor 10 has a swing arm 1, a back cover 2 and a front cover 3. The swing arm mechanism 1 and its manner of attachment to primary visor 10 is that used for conventional sun visors and its structure does not form a part of the present invention.

Back and front covers 2 and 3 are spaced apart and have opposing inner faces defining a slot. Back and front covers 2 and 3 have opposing first and second side edges and opposing upper and lower longitudinal edges. Back and front covers 2 and 3 are attached together at the opposing first and second side edges and at the opposing upper longitudinal edges. Opposing lower longitudinal edges define a longitudinal opening communicating the exterior of the primary visor with the slot formed between the opposing inner faces of back and front covers 2 and 3.

A visor extender 4 has inner and outer longitudinal edges and first and second side edges. Visor extender 4 is located in the slot between the back cover 2 and the front cover 3 and extends beyond the longitudinal opening defined by opposing lower longitudinal edges of back and front covers 2 and 3.

Visor extender 4 can be extended from the slot between the back and front covers 2 and 3 by pulling on grip bar 6. Grip bar 6 is illustrated as extending along a portion of the outer longitudinal edge of visor extender 4; however, it may extend along the entire length thereof.

Similarly, visor extender 4 can be retracted back into the slot between the back and front covers 2 and 3 by pushing on grip bar 6.

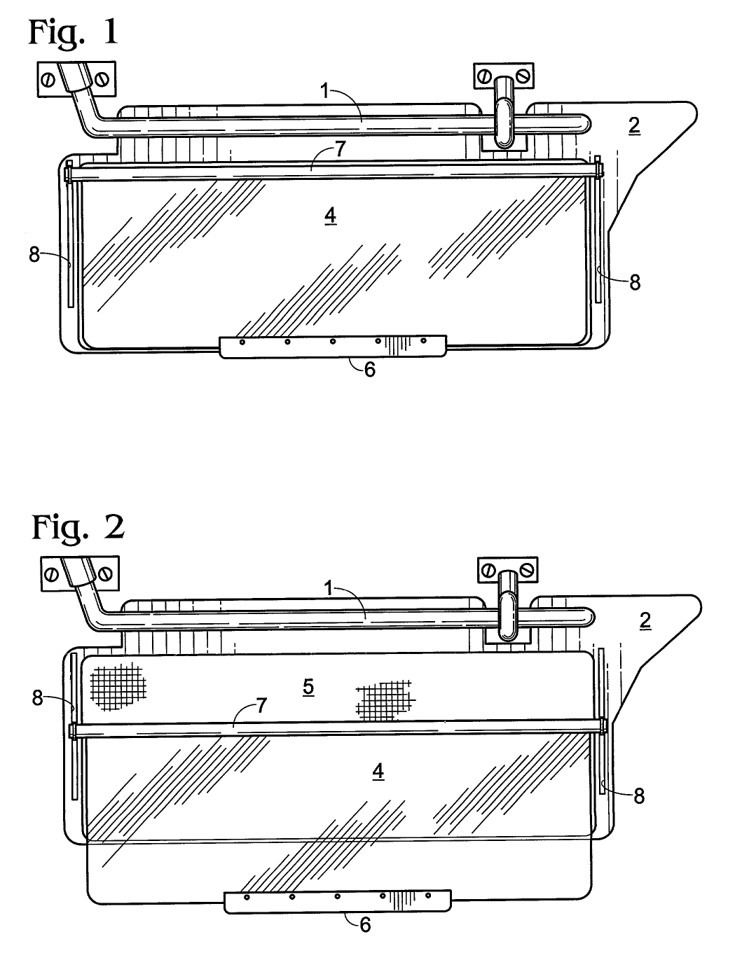

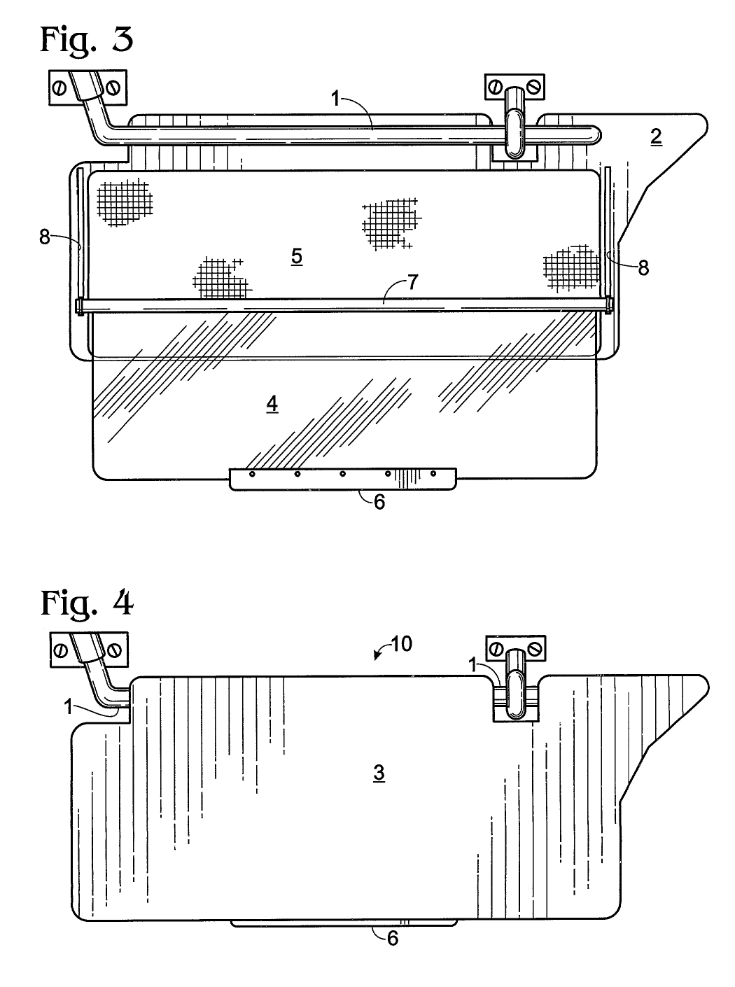

Stop bar 7 is attached to the inner longitudinal edge of visor extender 4. The outer ends of stop bar 7 extend beyond each of the side edges of visor extender 4, and they slide in grooves 8 located at the vertical edges of back and front covers 2 and 3. The grooves commence at the location of stop bar 7 shown in FIG. 1 and stop at the location of stop bar 7 shown in FIG. 3. Stop bar 7 limits the extension of visor extender 4 so that it cannot be pulled completely out of primary visor 10.

Scratch resistant fabric 5 is attached to the opposing inner faces of back and front covers 2 and 3 adjacent both planar faces of visor extender 4 to prevent its being scratched by back cover 2 and/or front cover 3 during extension and retraction.

Visor extender 4 is made of a material which cuts down on sun glare. It is preferred to make visor extender 4 of a UV resistant plastic in a green or amber color. Such materials are well known in the sun screening art.

It will be obvious to those having skill in the art that many changes may be made to the details of the above-described embodiments of this invention without departing from the underlying principles thereof. The scope of the present invention should, therefore, be determined only by the following claims.

The invention claimed is:

1. A visor for a motor vehicle comprising:
a primary visor having spaced apart front and back covers, said covers having opposing inner faces, opposing first and second side edges and opposing upper and lower longitudinal edges, said covers being attached at said opposing first and second side edges and along said opposing upper longitudinal edges, said primary visor having a longitudinal opening defined by said opposing lower longitudinal edges, said spaced apart front and back covers having a space between said opposing inner faces defining a slot;
a visor extender slidably received within said slot and extending through said longitudinal opening, said visor extender having first and second side edges and inner and outer longitudinal edges, a stop bar attached to said inner longitudinal edge, said stop bar having first and second ends extending beyond each of said first and second side edges, said first and second ends of said stop bar being received in first and second grooves extending between said front and back covers adjacent their opposing first and second side edges, said first and second grooves terminating adjacent said opposing lower longitudinal edges, said visor extender having a grip bar attached to at least a portion of said outer longitudinal edge of said visor extender.

2. The visor of claim 1 including a layer of scratch resistant fabric attached to the opposing inner faces of said first and second covers.

3. The visor of claim 1 wherein said visor extender is made of UV resistant plastic.

4. The visor of claim 3 wherein said plastic is green or amber in color.
